(19) United States
(12) Patent Application Publication
(10) Pub. No.: US 2006/0111915 A1
(43) Pub. Date: May 25, 2006

(54) Hypothesis generation

(75) Inventors: Peter W. Li, Brookeville, MD (US); Mark D. Yandell, El Cerrito, CA (US); William Majoros, Germantown, MD (US); Michael A. Harris, Silver Spring, MD (US); Rui Ru Ji, Princeton, NJ (US); Kendra Biddick, Clarksburg, MD (US); Gangadharan M. Subramanian, Ellicott City, MD (US); Jian Wang, S. Grafton, MA (US)

Correspondence Address: HARNESS, DICKEY & PIERCE, P.L.C., P.O. BOX 828, BLOOMFIELD HILLS, MI, 48303, US

(73) Assignee: Applera Corporation, Foster City, CA (US)

(21) Appl. No.: 11/180,034

(22) Filed: Jul. 12, 2005

Related U.S. Application Data
(63) Continuation-in-part of application No. 10/996,819, filed on Nov. 23, 2004.

(51) Int. Cl. G10L 21/00

(52) U.S. Cl. 704/275

(57) ABSTRACT

A hypothesis generation system includes a related concepts datastore recording relationships between core concepts in a field of study. A recognition module performs automatic recognition of a hypothesis recognition pattern respective of contents of the related concepts datastore. The recognition module records a hypothetical relationship between core concepts of the datastore based on recognition of the pattern.

### CROSS-REFERENCE TO RELATED APPLICATIONS

This application is a continuation-in-part of U.S. patent application Ser. No. 10/996,819 filed on Nov. 23, 2004. The disclosure of the above application is incorporated herein by reference in its entirety for any purpose.

### FIELD

The present disclosure relates to hypothesis generation systems and methods.

### INTRODUCTION

In Swanson, D. R., Fish oil, Raynaud's syndrome, and undiscovered public knowledge, Perspectives in Biology and Medicine, 30, 7-18 (1986), Don Swanson demonstrated that subtle associations among biomedical entities in literature could be used to generate hypotheses leading to genuine discoveries, such as novel uses for drugs. Weeber, M., Literature-based discovery in biomedicine, Phd Thesis, University of Groningen, (2001) involves the use of sentence-level co-occurrence networks to find transitive relations between diseases, biological processes, and dietary factors, and simulated Swanson's original Raynaud's disease-fish oil discovery. Other work in this area is described in Shatkay, H., Wilbur, W. J., Finding themes in medline documents, In Proc. Of IEEE Conf. on Advances in Dig. Libraries (ADL2000), (2000), which reports using the EM algorithm to identify themes and keywords or phrases in documents. However, the problem of powerful and reliable hypothesis generation remains unsolved, and its promise unfulfilled.

### SUMMARY

A hypothesis generation system includes a related concepts datastore recording relationships between core concepts in a field of study. A recognition module performs automatic recognition of a hypothesis recognition pattern respective of contents of the related concepts datastore. The recognition module records a hypothetical relationship between core concepts of the datastore based on the recognition of the predefined pattern.

These and other features of the present teachings are set forth herein. Further areas of applicability of the present teachings will become apparent from the detailed description provided hereinafter. It should be understood that the detailed description and specific examples are intended for purposes of illustration.

### BRIEF DESCRIPTION OF THE DRAWINGS

The skilled artisan will understand that the drawings, described below, are for illustration purposes only. The drawings are not intended to limit the scope of the present teachings in any way.

FIG. 1 is a block diagram illustrating an example of use of an embodiment of a hypothesis generation system in an Internet environment.

FIG. 2 is a block diagram illustrating an embodiment of the present teachings and shows a hypothesis generation system accomplishing hypothesis generation by applying a hypothesis recognition pattern to contents of a related concepts datastore.

FIG. 3 is a block diagram illustrating hypothesis recognition pattern extraction from a related concepts datastore.

FIG. 4 is a block diagram illustrating hypothesis recognition pattern reliability assessment based on logical analysis of results of test applications of the hypothesis recognition pattern to a related concepts datastore.

FIG. 5 is a block diagram illustrating hypothesis navigation, research strategy formulation, product demand prediction, and product development based on generated hypotheses.

FIG. 6 is a block diagram illustrating display of generated hypotheses and bases therefore to a user.

FIG. 7 is a flow diagram illustrating hypothesis generation, hypothesis navigation, research strategy formulation, product demand prediction, and product development.

### DESCRIPTION OF VARIOUS EMBODIMENTS

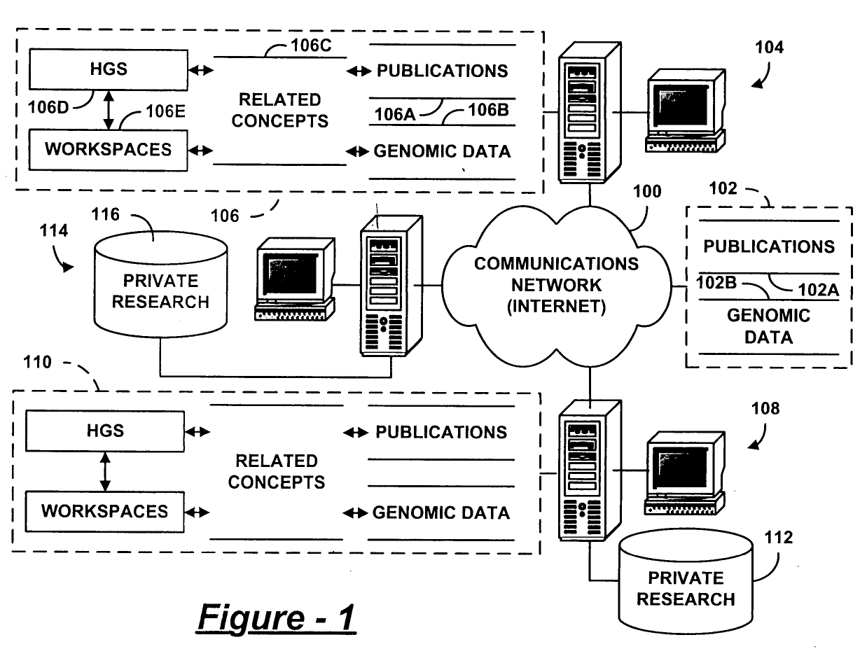

Starting with FIG. 1, an example of use of an embodiment of a hypothesis generation system in an Internet environment demonstrates some of the capabilities of the system. Accordingly, various types of users can employ the hypothesis generation system in a variety of ways. Different users can have different privileges of use as further explained below.

A communications system 100, such as the Internet, allows the public to access biotechnological information 102 in the public domain, such as publications 102A and genomic data 102B. A provider 104 of proprietary biotechnological information and related services 106 can access and process this public information 102 in addition to its own proprietary publications 106A and proprietary genomic data 106B. Various users, such as subscribers and non-subscribers to the proprietary information, can have different experiences when accessing a website of provider 104.

A relational database 106C of linked concepts provides an interface by which authorized users can access both public and private publications and genomic data. As further discussed below, this relational database 106C can be constructed by automated detection in contents of publications of co-occurrences of pre-specified key phrases. These key phrases can be related to core concepts identified in an expertly curated ontology. As also further discussed below, a hypothesis generation system 106D is capable of traversing a data structure formed by the relational database 106C. During the traversal, the system 106D can seek a pre-specified configuration of types of relationships between types of core concepts in order to hypothesize an unknown relationship between core concepts. During this process, the system 106D can obtain the pre-specified configuration by accessing user-specified criteria stored in a user workspace provided to the user as part of workspaces 106E. These workspaces 106E can be user-specific, with appropriate access control functionality, and some workspaces can be public and others partially or wholly private.

One type of user of the hypothesis generation system can be an editor employed by the provider 104. This editor can review the relational database 106C on a periodic basis to determine if new core concepts or relationships have been added during update of the database 106C. For example, the database 106C can be updated as a result of expert curation of the ontology of core concepts to add new concepts and/or new tiers of ontological categorization. Also, the relationships of database 106C can be updated as a result of automated analysis of new publications.

Upon review of the relational database, the editor may discover that a new relationship has been detected in the literature. For example, it may have been discovered that a drug that was useful for treating one disease may also be useful for treating another disease. The drug and the diseases can be considered core concepts, while the ability of the drug to treat the diseases can be separate relationships between these core concepts. In such a case, the editor can access the literature to look for clues as to what information may have led the researchers to hypothesize that the drug may treat the other disease. The editor can likewise view other core concepts related to the drug and/or diseases, such as genes/proteins, and look for a preexisting configuration that, in hindsight, might have suggested the possible existence of the previously unknown relationship. The new relationship, along with the surrounding, suggestive configuration of related and interrelated core concepts, constitutes a point of extraction for a hypothesis recognition pattern developed from this region of the relational database as further explained below.

Once the editor has identified a potential configuration of types of relationships between types of core concepts, the editor can create and store a hypothesis recognition pattern. This pattern can take the form of a data structure, code, or other information capable of identifying the configuration and the suggested relationship in a manner understandable to the hypothesis generation system. Then, the editor can perform a test run that causes the hypothesis generation system to apply the recognition pattern to the relational database 106C and identify potential, hypothetical relationships.

During a test run of a recognition pattern, there may be cases where the configuration is identified, but a known relationship contradicts the existence of the hypothetical relationship. These incidences of contradiction can be recorded for analysis by the editor. Thus, any resulting potential relationships can be assessed by the editor in an expert manner, and the editor can iteratively adjust and retest the configuration until predictions made by it seem reasonable to the editor.

Iterative adjustment and retesting of a recognition pattern constitutes an assessment procedure. Such procedures can be automatically recorded and used to generate assessment criteria in the form of an assessment history or a state machine. These assessment criteria can later be analyzed and/or edited by a user. They can also later be automatically applied by the system 106D to analyze future recognition patterns at a user's option.

Once the editor has obtained a recognition pattern that the editor has deemed reliable, the editor can relax constraints on node and relationship types to develop a hypothesis recognition pattern extraction template. Then, the editor can use the template to identify other, potential recognition patterns by traversing the relational database data structure to find potential extraction points, and then applying assessment criteria to analyze these potential recognition patterns. Upon review of the results, the editor can iteratively adjust the individual constraints of the extraction template, apply assessment criteria, and review the results.

Iterative adjustment and retesting of a recognition pattern template constitutes an extraction procedure. Such procedures can be automatically recorded and used to generate extraction criteria in the form of an extraction history or a state machine. These extraction criteria can later be analyzed and/or edited by a user. They can alternatively or additionally later be automatically applied by the system 106D to extract potential recognition patterns at a user's option.

It is envisioned that the system 106D can construct a state machine from an extraction and/or assessment history in an automated fashion. The resulting state machine captures the logical process for conditional performance of an extraction and/or assessment under the conditions encountered during the extraction or assessment process. These conditions can relate to the characteristics of the template and/or pattern being employed, the contradictions encountered following a test run, and the adjustments made in various circumstances, and/or the circumstances surrounding final rejection or acceptance of a template or pattern. It is also envisioned that the system 106D can recognize substantial similarity between multiple state machines for similar templates or patterns. In this case, the system 106D can create a new state machine that combines the characteristics of the multiple state machines to account for conditions that have been encountered during separate, expertly directed assessments. It is further envisioned that a user can evaluate and edit state machines as desired, and even author one entirely.

Following development of one or more recognition patterns deemed reliable by the editor, the editor may store one or more recognition patterns in the editor's workspace. The editor can also store any related assessment criteria and/or extraction criteria in the workspace, along with the point of extraction from which the recognition pattern was developed. Other authorized users can then access the editor's workspace to obtain the hypothesis recognition pattern, and use it to see for themselves the hypotheses predicted by it in the relational database 106C.

As mentioned above, it is envisioned that some users may have privileges to view the proprietary information and the public information, while others have privileges to view only the public information. In this case, there can be two different relational databases, with one developed respective of only publicly available information, and the other developed respective of both publicly and privately available information. Accordingly, there can be recognition patterns that are developed with respect to one relational database or the other, and users not authorized to access the proprietary information may not have privileges to access hypothesis recognition patterns developed based on the proprietary information.

Another user of the system can be an employee of a subscribing user 108, such as a drug company, that subscribes to the proprietary information and services 106. This subscribing user 108 can periodically download a copy 110 and/or updates of the information and services to a private research environment. By downloading the copy 110 of the proprietary information and then only accessing the copy 10 of the information during research activities in the private research environment, the subscribing user 108 can be assured that the public will not be able to determine the subscribing user's direction of research simply by analyzing search queries that would otherwise be routed over the Internet. The subscribing user can also privately assess the editor's hypotheses and criteria in view of the subscribing user's private research data 112. During this process, the subscribing user can freely evaluate and adjust the recognition patterns, recognition results, and assessment and extraction criteria. Thus, new patterns and criteria can be developed and stored in the subscribing user's private workspace onboard the copy 110. The subscribing user can also operate in the same manner as the editor, but with respect to the copy.

In contrast to the subscribing user, a non-subscribing user 114, such as a researcher at a university, does not subscribe to the proprietary information and services 106. Accordingly, the non-subscribing user 114 is not privileged to view the proprietary information or download a copy of the information and services 106. Accordingly, the non-subscribing user 114 must use the system 106D on the website of the provider 104, and can only access a relational database 106C that is developed from publicly available information. Also, any hypothesis recognition patterns and related criteria developed by the non-subscribing user 114 must similarly be stored in a workspace 106E accessible to the non-subscribing user 114 on the website of the provider 104. Thus, any of the non-subscribing user's private research data 116 that is embodied in the non-subscribing user's user-specific recognition patterns and/or related criteria may be revealed to other users if the non-subscribing user's workspace is entirely public. As a result, the non-subscribing user's workspace may be public or private, and may have a partition of public and private data that the researcher can define. Thus, sharing of information can be accomplished between users in a fashion that is agreeable to all users.

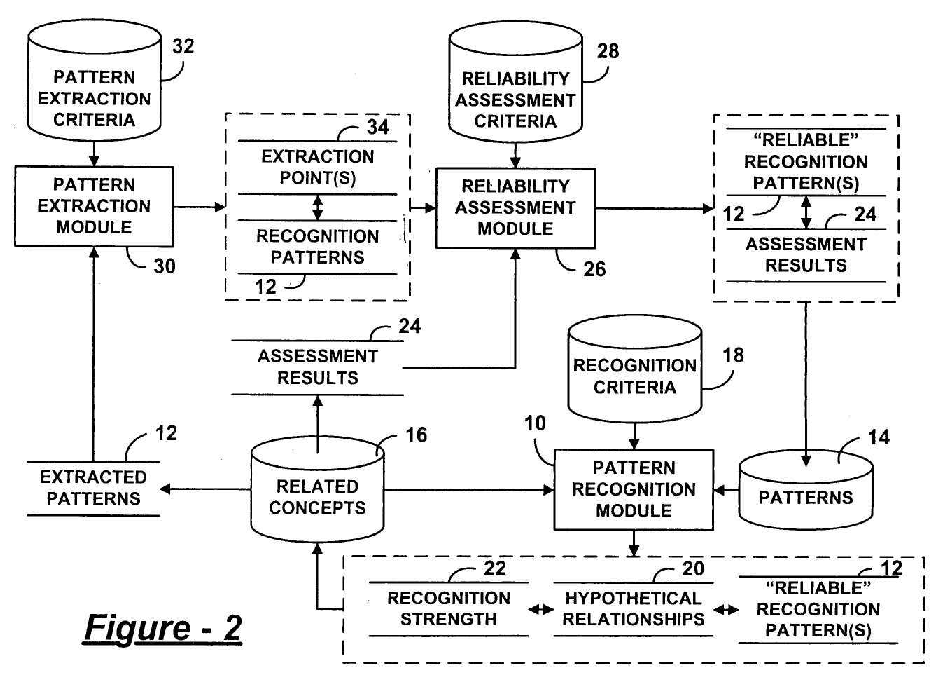

Further details of various embodiments of the hypothesis generation system are provided below with reference to FIGS. 2-7. Turning now to FIG. 2, hypothesis generation system 10 accomplishes hypothesis generation by applying a hypothesis recognition pattern 12 of pattern datastore 14 to contents of a related concepts datastore 16. Related concepts datastore 16 records relationships between core concepts in a field of study, such as biomedicine. The core concepts are hierarchically arranged in one or more interrelated ontologies as more fully discussed in U.S. patent application Ser. No. 10/996,819, entitled Literature Pipeline, and filed Nov. 23, 2004 by the Assignee of the present application. The aforementioned application is incorporated by reference herein in its entirety for any purpose.

Literature Pipeline describes in detail a technique for generating and navigating relationships between core concepts based on detection of co-occurrence of the core concepts in document contents. However, it is envisioned that semantic parsing can additionally or alternatively be employed. Accordingly, the present teachings suppose the existence of a graph data structure, with graph nodes corresponding to core concepts in a field of study, and with edges between nodes corresponding to relationships between the core concepts. It is envisioned that some of the edges can be predefined by a curator during ontological organization of the core concepts, while others can be generated and recorded during a literature mining process. It is further envisioned that an edge generated from literature mining can have pointers to locations in document contents that support the existence of the relationship. It is yet further envisioned that the datastore 16 can be navigable, such that a graphic display of its contents can be provided in the form of a graph data structure to a user, and that the user can access a concept ontology and/or literature on relationships by clicking on graphic display components.

Given a related concepts datastore 16 as described above, pattern recognition module 10 can use recognition criteria of datastore 18 to traverse the graph data structure of related concepts and identify an occurrence of a recognition portion of the pattern 12 at a point in the graph data structure. Then, module 10 can record a hypothetical relationship 20 in datastore 16 based on a prediction portion of the pattern 12 that specifies a type of relationship between two nodes of the data structure in a predetermined position respective of the point of occurrence and elements of the recognition portion.

Module 10 can assign a weight to the hypothetical relationship 20 in the form of a recognition strength 22. Module 10 can calculate the recognition strength 22 based on an initial strength assigned to the recognition pattern, and then automatically adjust the initial strength based on recognition criteria of datastore 18. For example, the recognized occurrence can include relationships that are hypothetical and have their own recognition strengths. Accordingly, recognition criteria can specify that a relationship hypothesized based on an occurrence of the recognition portion that is itself at least partially hypothetical should have its initial recognition strength reduced by a given factor.

The given factor can be constant, or it can be cumulative based on recognition strengths of hypothetical relationships existing in the occurrence. In some embodiments, recognition strength can be defined as a scalar between zero and one. In this case, a hypothetical relationship's recognition strength can be the product of its initial strength and the recognition strengths of other hypothetical relationships recorded in the identified occurrence. Also, a threshold can be specified in recognition criteria that can ensure that a hypothetical relationship is only recorded if it has a sufficient recognition strength. Dependence of a hypothetical relationship on confirmation of another hypothetical relationship can also be recorded by module 10, with a pointer specifying which hypothetical relationship needs to be confirmed.

Initial recognition strength of a recognition pattern 12 is recorded with the pattern 12 in datastore 14 as part of assessment results 24 provided by reliability assessment module 26. Module 26 applies assessment criteria of datastore 28 to a recognition pattern 12 in order to assess its reliability. The assessment criteria can constitute machine executable instructions for performing trial recognition runs of the recognition pattern 12 in datastore 16 to determine if and to what degree the hypothesis is confirmed and contradicted in datastore 16. The assessment criteria can also include instructions for generating and testing slight variations of the received recognition pattern 12 in a predetermined fashion; module 26, for example, can impose and/or relax constraints on edge and/or node types in the recognition and hypothesis portions. Accordingly, the recognition pattern 12 passed from module 26 to datastore 14 can differ from the pattern 12 received by module 26, and the assessment results 24 can reflect the original pattern 12 and results of trial recognition runs.

The recognition pattern 12 received by module 26 can be directly defined by a user, such as a curator, or automatically extracted from related concepts datastore 16 by pattern extraction module 30. Pattern extraction module 30 extracts patterns 12 from datastore 16 according to pattern extraction criteria of datastore 32. Pattern extraction criteria can specify a graph data structure with constraints on node and edge types, plus machine executable instructions for creating multiple recognition patterns based on contents of datastore 16 at one or more extraction points 34 fitting the constraints. Accordingly, an extraction point 34 of a recognition pattern 12 and the extraction criteria leading to extraction of the recognition pattern can be included in the assessment results 24 of the pattern 12, along with comments from one or more users, such as a curator or customer.

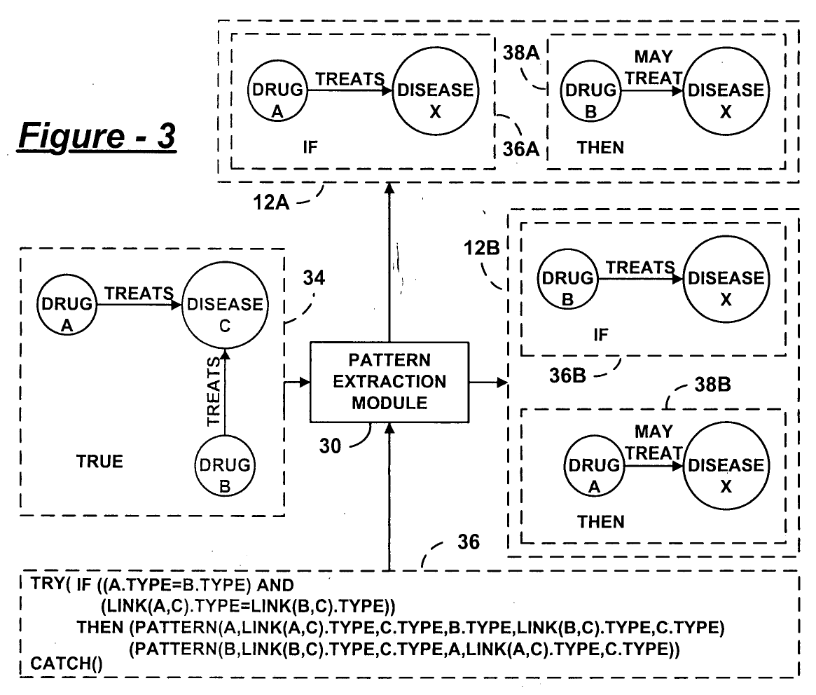

Turning now to FIG. 3, aspects of the present teachings may be further understood in light of the following examples of hypothesis recognition pattern extraction from the related concepts datastore, which should not be construed as limiting the scope of the present teachings in any way. For example, pattern extraction module 30 receives pattern extraction criteria 36 specifying that if two nodes of the same type relate in the same way to a third node, then two recognition patterns can be generated. Specifically, criteria 36 specify that a first pattern 12A can be created that hypothesizes that if a first node links in a first way to a third node of a third type, then a second node can link to the third node in a second way. Criteria 36 also specify that a second pattern 12B should be created that hypothesizes that if the third node links in the second way to a third node of the third type, then the first node can link to the third node in the first way. Accordingly, module 30 traverses the related contents datastore and identifies an extraction point 34 that meets the constraints imposed by the extraction criteria 36. In the example, the extraction point 34 specifies that two different drugs are known to treat a particular disease. Accordingly, the specific or generalized node and relationship types are extracted from point 34 in creating recognition portions 36A and 36B and hypothesis portions 38A and 38B of recognition patterns 12A and 12B.

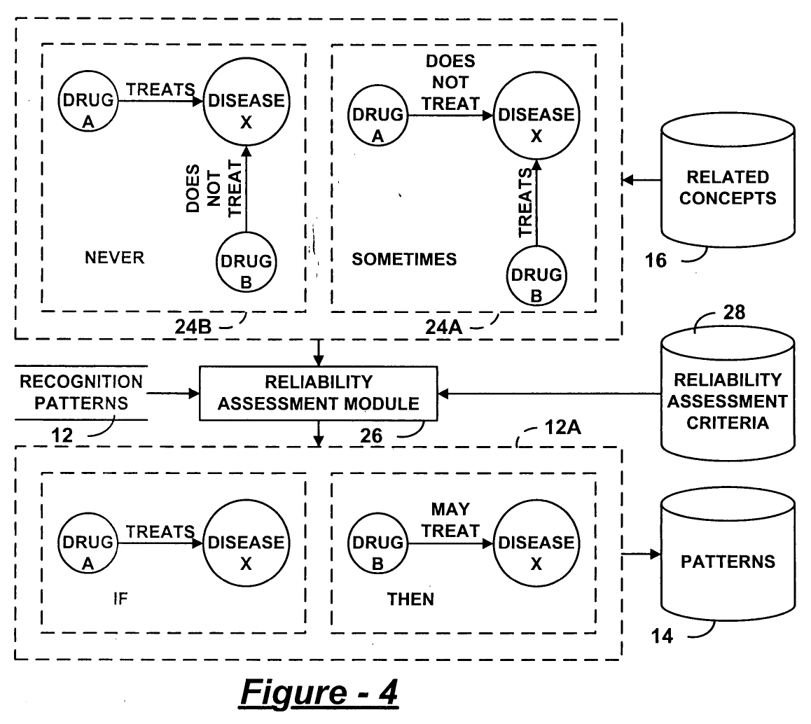

Continuing with FIG. 4, the extracted recognition patterns are communicated to reliability assessment module 26, which uses reliability assessment criteria of datastore 28 to test the multiple hypotheses 12. For example, assessment criteria of datastore 28 cause module 26 to traverse related concepts datastore 16 and find occurrences of the recognition portions of the patterns 12. Then, assessment criteria of datastore 28 cause module 28 to determine a number of confirmations and/or contradictions of the hypotheses portions respective of the found occurrences of the recognition portions. The assessment results 24A can record, for example, that it is never the case that a second drug does not treat a particular disease if a first drug treats that disease. Results 24B can similarly record that it is sometimes the case that the first drug does not treat a particular disease even though the second drug treats that disease. Next, assessment criteria of datastore 28 can specify logical analysis criteria for screening the patterns 12 based on the assessment results 24A and 24B. For example, it can be reasonable to hypothesize, based on the example assessment, that a second drug may treat a particular disease if the first drug treats that disease. Conversely, it can be less reasonable to hypothesize, based on the example assessment, that the first drug may treat a particular disease if the second drug treats that disease. Accordingly, the assessment criteria of datastore 28 can specify that the second recognition pattern should be screened out or assigned a lesser recognition strength than the first recognition pattern 12A. In the case where the second recognition pattern is screened out, the second recognition pattern can be discarded, whereas the first recognition pattern 12A can be recorded in pattern datastore 14.

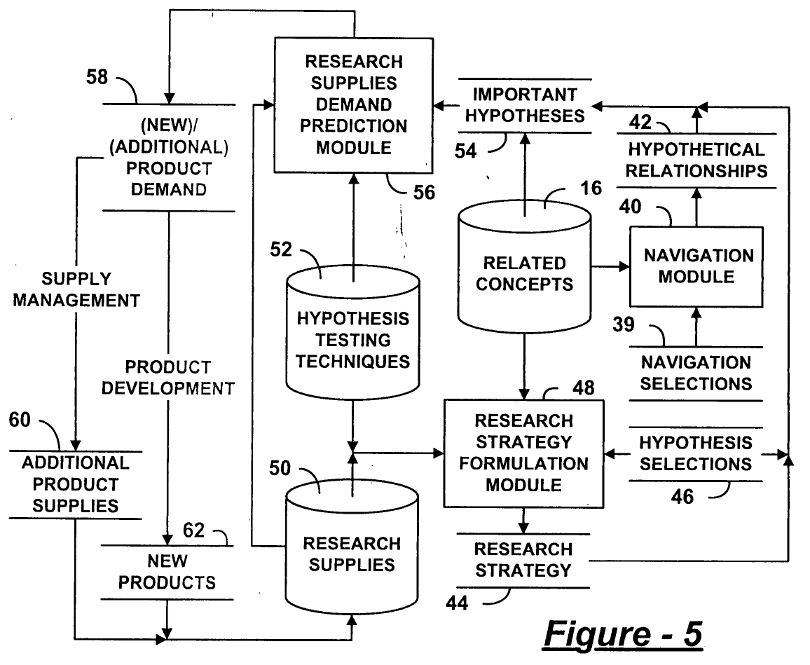

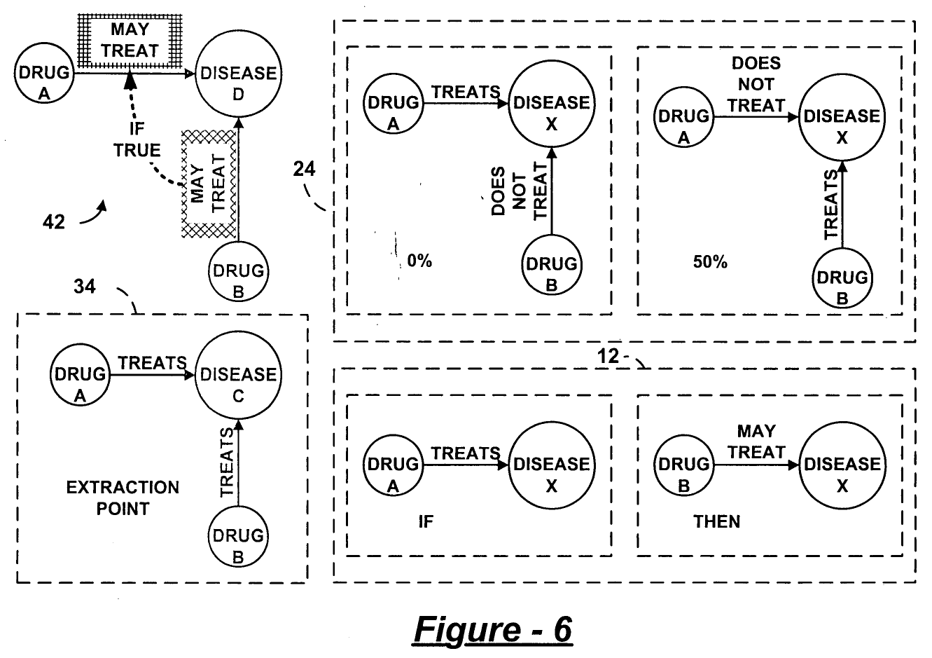

FIG. 5 illustrates various uses of the generated hypotheses, including hypothesis navigation, research strategy formulation, product demand prediction, and product development. For example, users can navigate the related concepts datastore 16 containing the recorded hypotheses by entering navigation selections 38 to navigation module 40. In this way, users can view the hypothetical relationships 42 as illustrated in FIG. 6 at 42. Accordingly, users can see the hypothetical relationships co-displayed with known relationships. Also, display properties of the relationships, such as hue, can differentiate hypothetical relationships from known relationships and communicate recognition strength as a measure of hypothesis reliability. Further, dependence of one hypothesis on another can be communicated by additional display components, such as an arrow between hypothetical edges indicating the dependence.

The hypotheses thus displayed are accountable in several other ways. For example, users can click on a hypothesis and view the related recognition pattern 12, extraction point 34 and/or criteria, and/or assessment criteria and/or results 24 that led to generation of the hypothesis. Also, users can adjust the recognition threshold and substitute their own extraction and assessment criteria for those of another user, such as a curator. It is envisioned that user can generate extraction, assessment, and recognition criteria in a textual programming environment. It is also envisioned that a graphical programming environment can be provided to users that allows selection of displayed contents of datastore 16, and automatically generates extraction criteria and/or recognition patterns based on characteristics of the selected contents. Such a graphical programming environment can include controls permitting users to specify specific nodes, node types, relationship types, and correspondence between node types and edge types. In addition, such controls can permit users to specify ranges of types within an ontology organizing the nodes and/or relationship types. For example, a user can be allowed to specify that a node of a recognition portion must be a particular gene node, any gene node, or a subset of genes defined as a subclass of gene within a predefined ontology. Also, a user can be permitted to specify that two nodes must be of a same type, or within a range of ontological type to one another. The user can further be allowed to specify that the assessment can modify these constraints in a predetermined way and generate assessment results for automatic or curated review. As a result, one user, such as a customer, can scrutinize another user's, such as a curator's, methods in generating hypotheses; then users can apply their own hypothesis generation preferences.

Returning to FIG. 5, users can formulate a research strategy 44 by making hypothesis selections 46 and communicating them to research strategy formulation module 48. Module 48 can then access research supply datastore 50 and testing method datastore 52 and apply cost functions to determine efficient research strategies for resolving the hypotheses. It is envisioned that a hypothesis not selected or even viewed by the user can be identified as important in efficiently resolving the hypotheses selected by the user. It is also envisioned that users can specify budgetary constraints, existing supplies, and other considerations that can affect the development of the research strategy 44.

Important hypotheses 54, such as those selected by users and identified by research strategy formulation module 48, can be used by research supplies demand prediction module 56 to predict product demand 58. Module 56 can use knowledge of existing products and testing techniques to predict demand for new products. This prediction of product demand 58 can then be fed into a supply management or product development process, resulting in additional research product 60 and/or new products 62. For example, if various disease-specific micro arrays have been developed to screen for various genes, and several other genes are hypothetically linked to these diseases, then a prediction can follow for demand for a supplemental micro array that tests for all of these other genes based on an expectation that researchers who have already purchased or can purchase existing micro arrays can be interested in these genes as well. Demand for a new set of micro arrays to replace the existing products can also be predicted.

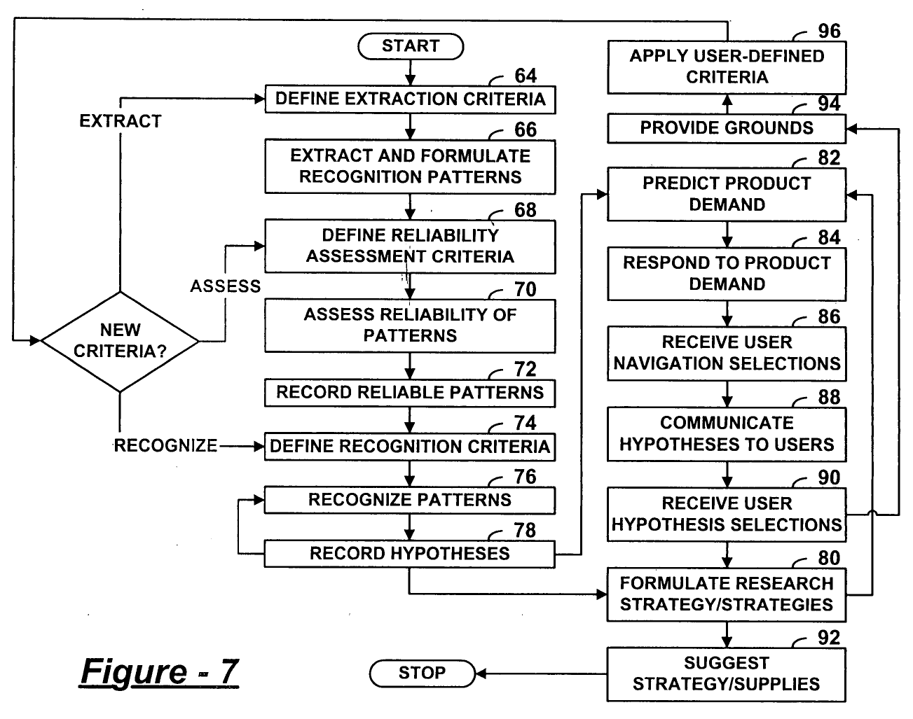

A method of hypothesis generation, hypothesis navigation, research strategy formulation, product demand prediction, and product development is explored in FIG. 7. Initially, extraction criteria are defined in step 64, and these criteria are used in step 66 to extract and formulate recognition patterns. Next, reliability assessment criteria are defined in step 68 and applied in step 70 to assess reliability of the recognition patterns. Then, reliable patterns are recorded in step 72, and recognition criteria are defined in step 74. The recognition criteria then are iteratively applied in steps 76 and 78 to recognize and record hypotheses.

These generated hypotheses are used in step 80 to formulate research strategies which are used in step 82 in conjunction with the hypotheses to predict product demand. The prediction of product demand is responded to at step 84 to ensure availability of products to users. Then, when user navigation selections are received at step 86 and hypotheses communicated to users at step 88, the selection of hypotheses of interest by the user at step 90 can lead to communication to the user of a user-specific research strategy and related supplies at step 92. Users can also review grounds for selected hypotheses at step 94 and apply their own criteria at step 96 to extract, assess, and recognize hypotheses at steps 64-78. Observation of user specified criteria can also lead to communication of new hypotheses to the user at step 88 and formulation of new research strategies at step 80. It can further lead to development of customized assays for the user at steps 82-84.

Those skilled in the art can now appreciate from the foregoing description that these broad teachings can be implemented in a variety of forms. Therefore, while the literature pipeline has been described in connection with particular examples thereof, the true scope thereof should not be so limited since other modifications will become apparent to the skilled practitioner upon a study of the drawings, the specification and the following claims.

What is claimed is:

1. A hypothesis generation system, comprising:
a related concepts datastore recording relationships between core concepts in a field of study; and
a recognition module performing automatic recognition of a hypothesis recognition pattern respective of contents of the related concepts datastore, and recording a hypothetical relationship between core concepts of the datastore based on the recognition of the pattern.

2. The system of claim 1, further comprising a reliability assessment module performing an assessment of reliability of a hypothesis recognition pattern, and recording the hypothesis recognition pattern in a pattern datastore of predefined patterns based on the assessment.

3. The system of claim 2, wherein said reliability assessment module subjects the hypothesis recognition pattern to a logical analysis.

4. The system of claim 3, wherein said reliability assessment module determines whether known relationships exist in the related concepts datastore that contradict the hypothesis recognition pattern.

5. The system of claim 3, further comprising a pattern extraction module performing automatic extraction of a pattern of relationships between core concepts based on pattern extraction criteria, and formulating the hypothesis recognition pattern based on the pattern extraction criteria.

6. The system of claim 1, wherein said recognition module distinguishes between hypothetical relationships and known relationships of the related concepts datastore.

7. The system of claim 6, wherein said recognition module records whether existence of the hypothetical relationship depends on confirmation of another hypothetical relationship.

8. The system of claim 1, further comprising a research supplies demand prediction module predicting demand for a new product based on the hypothetical relationship.

9. The system of claim 1, further comprising a hypotheses navigation module receiving user navigation selections respective of contents of the related concepts datastore, and communicating the hypothetical relationship to the user in response to the navigation selections.

10. The system of claim 1, further comprising a research strategy formulation module formulating a research strategy based on the hypothetical relationship.

11. A hypothesis generation method, comprising:
accessing a related concepts datastore recording relationships between core concepts in a field of study;
performing automatic recognition of a hypothesis recognition pattern respective of contents of the related concepts datastore; and
recording a hypothetical relationship between core concepts of the datastore based on recognition of the hypothesis recognition pattern.

12. The method of claim 11, further comprising:
performing an assessment of reliability of a hypothesis recognition pattern; and
recording the hypothesis recognition pattern in a pattern datastore of predefined patterns based on the assessment.

13. The method of claim 12, wherein performing the assessment includes subjecting the hypothesis recognition pattern to a logical analysis.

14. The method of claim 13, wherein performing the assessment includes determining whether known relationships exist in the related concepts datastore that contradict the hypothesis recognition pattern.

15. The method of claim 13, further comprising:
performing automatic extraction of a pattern of relationships between core concepts in the datastore based on pattern extraction criteria; and
formulating the hypothesis recognition pattern based on the pattern extraction criteria.

16. The method of claim 11, wherein performing recognition includes distinguishing between hypothetical relationships and known relationships of the related concepts datastore.

17. The method of claim 16, wherein recording the hypothetical relationship includes recording whether existence of the hypothetical relationship depends on confirmation of another hypothetical relationship.

18. The method of claim 11, further comprising designing new research supplies based on the hypothetical relationship.

19. The method of claim 11, further comprising:
receiving user navigation selections respective of contents of the related concepts datastore; and
communicating the hypothetical relationship to the user in response to the navigation selections.

20. The method of claim 11, further comprising formulating a research strategy based on the hypothetical relationship.
